(19) United States
(12) Patent Application Publication
(10) Pub. No.: US 2020/0016853 A1
(43) Pub. Date: Jan. 16, 2020

(54) PROFILED MEMBER WITH A TEAR STRIP

(71) Applicant: EPSILON COMPOSITE, Gaillan en Medoc (FR)

(72) Inventors: Denis FERRER, Vertheuil (FR); Ambroise LATRON, Hourtin (FR)

(73) Assignee: Epsilon Composite, Gaillan en Medoc (FR)

(21) Appl. No.: 16/469,402

(22) PCT Filed: Nov. 20, 2017
(86) PCT No.: PCT/FR2017/053180

§ 371 Date: Oct. 1, 2019

(30) Foreign Application Priority Data
Dec. 13, 2016 (FR) 1662359

(51) Int. Cl. B29C 70/52; B29C 70/54

(52) U.S. Cl. CPC B29C 70/52; B29L 2031/001; B29C 70/545

(57) ABSTRACT

A profiled member having two faces and having at least one tear strip with two edges arranged on and adhered to one face of said profiled member, the tear strip having at least one non-adhered edge. The non-adhered edge makes it possible not only to more easily take hold of and remove the tear strip, but also prevents a piece of the tear strip from remaining on the profile member and hindering the adhering of the profiled members to each other. The two edges of the tear strip may be non-adhered, and, when the profile member is covered by a tear strip on each face, the two tear strips are each non-adhered on at least one side. The profile member can be either flat or circular.

### TECHNICAL FIELD OF THE INVENTION

The present invention relates to a profiled member which is designed to be glued on another profiled member which is designed in particular to provide reinforcements of wind turbine blades, wind turbine blades, or laminar/glued beams which are used for example in civil engineering, and the production process thereof.

The gluing of these two profiled members to one another can for example be used to produce reinforcements as described in patent EP2497945.

In order to facilitate the gluing of the profiled members to one another, a peelply (or peel ply) is provided, which is also known as tear or delamination fabric by persons skilled in the art, on at least one of its two faces, and which strip will be removed before the profiled members are glued. This peelply makes it possible to obtain a surface of the profiled member which is both neat and sufficiently rough to facilitate the coupling of the two profiled members to one another.

### PRIOR ART

This peelply can be put into place during the process of production of the profiled member, but it is then found that a rim is formed on the profiled member on the periphery of the peelply.

When the peelply is removed, this rim will remain in relief on the side of the profiled member, and will firstly prevent optimum contact between the profiled member and the one on which it must be glued, and secondly, during tearing away in cold conditions, it will occasionally give rise to tearing of the peelply, and/or leave residual fibers on the profiled member, thus impeding its gluing. An additional cleaning operation must then be carried out in order to finalize the preparation for gluing of the profiled member. There is also the possibility of covering of the peelply by carbon fibers and/or matrix in the process, and this covering embeds the edges of the strip, which can thus increase significantly the probability of giving rise to tearing or residual fibers as described above.

Although the removal of the peelply is relatively easy when it is made of polyamide (PA) and/or when the profiled member is made of carbon-vinylester, it can be particularly difficult if a thermoplastic such as polyester (PES) is used in the place of the PA for a peelply with a profiled member made of carbon/epoxide.

It is possible to carry out surface abrasion instead of and in the place of the peelply, but there is then the presence of dust which requires cleaning with solvent before application of the glue.

It is also possible to carry out surface preparation which is not mechanical, but only chemical (primer or cold plasma, etc.), which leads to an increased risk of fatigue fracture of the gluing, since the surface of the profiled member remains substantially flat.

It is additionally possible to use an anti-adhesion agent placed below the peelply, but this agent detracts from the adhesion of the faces to be glued.

It is known to use a film below the corner or the edge of a connection layer in order to facilitate its tearing away and the formation of a fissure on the surface of the compound, but this film represents an additional cost for the production of the profiled member.

It is additionally known to turn back the edge of the peelply in order to obtain a grip, however this solution is not satisfactory since it requires a peelply which is larger than the surface of the profiled member, it is more difficult to put into place, and is thus more costly to implement.

### SUMMARY OF THE INVENTION

The objective of the invention is to propose a process for production of a profiled member with a peelply which does not have these disadvantages, and to propose the profiled member obtained.

The invention relates to a process for production of a profiled member, and is characterized in that it comprises a step of adhering a peelply, and a step of unsticking at least one edge of the peelply, in that the profiled member is pultruded, and in that the step of unsticking is carried out at the output from the die. The profiled member obtained is thus easier to use. During standard pultrusion steps, there is impregnation, drying and polymerization in a die. According to the invention, the unsticking starts to be carried out in the manufacturing line by blades at the output from the die, when the product is still at a suitable temperature at the end of polymerization, the protruded product is drawn and wound along the length of the flat parts with the peelplies prepared for tearing away along all or part of the profiled member. The profiled member obtained has two faces with at least one peelply with two edges disposed and glued on a face of said profiled member, and the peelply of which has at least one edge which is unstuck. The edge thus unstuck makes it possible to grip the peelply easily by hand, and remove it more easily, as well as to prevent an end of the peelply remaining on the profiled member and impeding the gluing of the profiled members to one another. The two edges of the peelply can be unstuck, and, when the profiled member is covered by a peelply on each face, the two peelplies are each unstuck at one side at least. The profiled member can have a flat or circular form. In addition, since the profiled member is made of a pultruded composite material, it has high-level transverse mechanical performance, and in particular a profile made of carbon/epoxide has high mechanical performance levels perpendicular to the preferential direction of the reinforcement fibers which are up to 5 times better than those of a profiled member made of carbon/vinylester.

Advantageously, the step of unsticking is carried out by a blade. This blade can be disposed at the end of the process of production of the profiled member, and can thus be automated. This makes possible a saving in labor and elimination of the finishing operations. The parts can have any form and cross-section which can be produced by pultrusion.

Advantageously, the step of unsticking is carried out in hot conditions. Hot preparation of the peelply makes it possible to reduce the constraints of coupling of the strip on the profiled member. Ideally, the temperature should be close to the vitreous transition temperature Tg of the matrix of the compound, for example a minimum temperature of 20° C. below the Tg.

Preferably, the unsticking in hot conditions can be carried out during the polymerization process, in order to benefit from incomplete resistance of the matrix, and thus facilitate the unsticking.

Advantageously, the blade has an inclination relative to the plane of the profiled member. It is thus certain that no rim remains on the profiled member.

Advantageously, the blade is aligned with the plane of the profiled member. The profiled member thus has a globally flat surface.

Advantageously, the profiled member and the peelply are machined at the second edge of the peelply. This machine makes it possible to eliminate the rim which appears on the profiled member, and thus permit the contact of the profiled member over all of the surface corresponding to the peelply. It is possible for both edges to be machined, and there is then no unsticking of the peelply. The machining can be partial or total.

Advantageously, a side of the profiled member is covered with a veil at the second edge of the peelply, and said veil is placed below the edge of said peelply. The veil disposed on the side of the profiled member makes it possible to prevent possible covering of the peelply by carbon fibers and/or matrix which is formed in the process. Both edges of the profiled member can be covered with a veil. There is then no unsticking of the peelply.

According to a particular arrangement, at least one edge of the peelply is turned back. When thus turned back, the peelply prevents any insertion in the rim of the profiled member. The turned-back edge can easily be released. It is possible for all the edges of the peelply to be turned back.

The invention also relates to a profiled member with two faces having at least one peelply with two edges disposed and glued on a side of said profiled member, and characterized in that it is produced by the process having at least one of the preceding characteristics.

The invention also relates to an assembly comprising at least two profiled members with at least one of the preceding characteristics, and characterized in that the two profiled members are glued to one another. It is also possible to glue the profiled member on other types of surfaces such as concrete, steel, etc.

### DESCRIPTION OF THE FIGURES

Other advantages may also become apparent to persons skilled in the art from reading the examples below, illustrated by the appended figures, and provided by way of example:

FIG. 1 is a view in cross-section of a profiled member covered with a peelply according to the prior art;

FIG. 1a shows the detail A in FIG. 1;

FIG. 2 is a view in cross-section of two glued profiled members according to the prior art;

FIG. 3 is a profiled member according to the invention with different positions of the blade;

FIGS. 3a and 3b illustrate the detail B of FIG. 3, with two other possible positions of the blade;

FIG. 4 is a first variant of a profiled member according to the invention;

FIG. 5 is a second variant of a profiled member according to the invention;

FIG. 6 illustrates a third variant of a profiled member according to the invention.

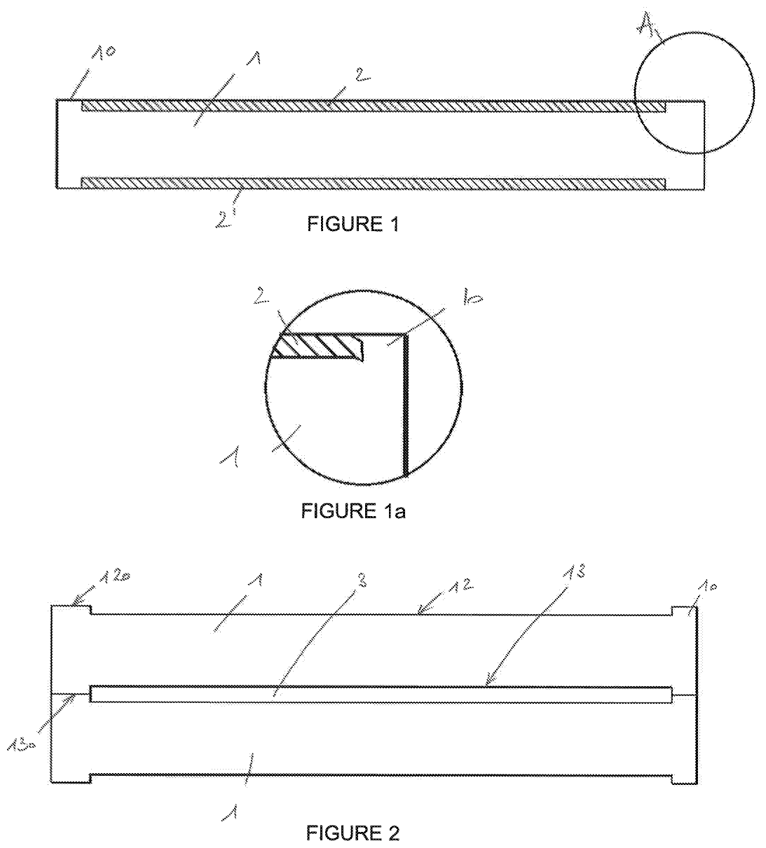

The profiled member 1 according to the prior art, illustrated in FIG. 1, is covered by a peelply 2, and this peelply 2 is disposed on the profiled member during its production, consequently creating a rim 10 between the edge of the peelply 2 and the end of the profiled member 1. This rim 10 can embed the end of the peelply 2, as shown in the detail in FIG. 1a. After the strip 2 has been removed, the rim 10 remains, and during the gluing of the profiled members 1 to one another, a space 3 remains, thus limiting the gluing of the faces 12 and 13 of the profiled members to restricted areas 120 and 130. It can also be seen that the rim 10 impedes the grasping of the peelply 2, resulting in a risk of tearing and/or remaining of fibers on the rim 10.

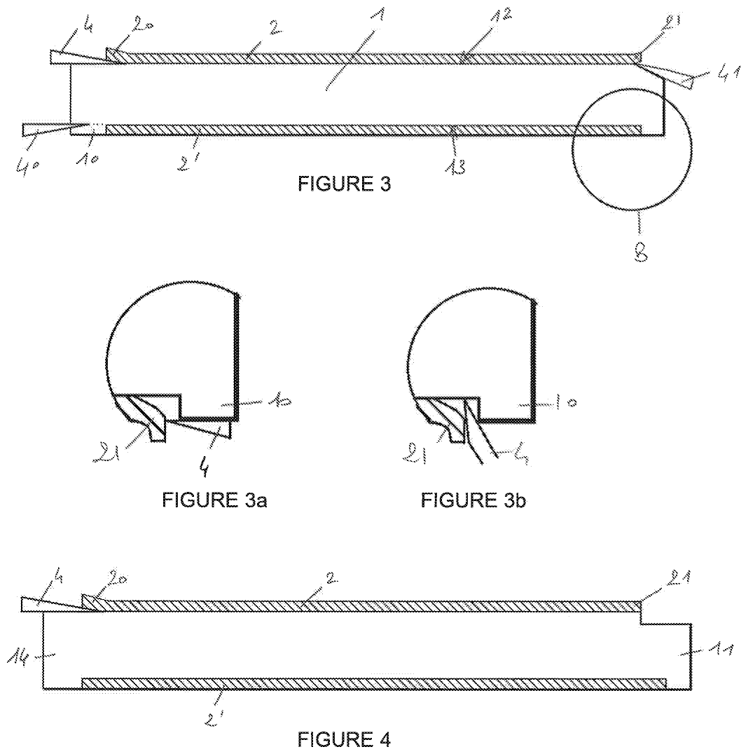

The profiled member according to the invention, illustrated in FIG. 3, shows a blade 4 cutting the rim 10 of the profiled member, and unsticking the edge 20 of the peelply 2. A second blade 40 is disposed on the other face, in order to unstick the second peelply 2′. In this example, the blade 40 has not completely cut the rim 10. The blade is mobile, so that it can be positioned according to the width of the strip. On the other side, a variant is illustrated, where a third blade 41 is inclined relative to the plane of the profiled section 1, thus making it possible to ensure that the gluing surface of the profiled members corresponds to an area where the peelply 2 was positioned.

FIGS. 3a and 3b show two other possible arrangements of the blade 4, parallel to the rim 10 (FIG. 3a) or inclined (FIG. 3b).

In FIG. 4, according to a first variant, a side 11 of the profiled member 1 is machined partly in order to release the edge 21 of the peelply 2, and thus facilitate access to it. In the case when the profiled member 1 comprises two peelplies 2 and 2′, both faces 12 and 13 of the profiled member 1 will be machined. The machining can also be carried out on all of the thickness of the profiled member 1, thus releasing the two peelplies 2 and 2′. It is also possible to machine both sides 11 and 14 of the profiled member 1. There is then no unsticking of the peelply 2.

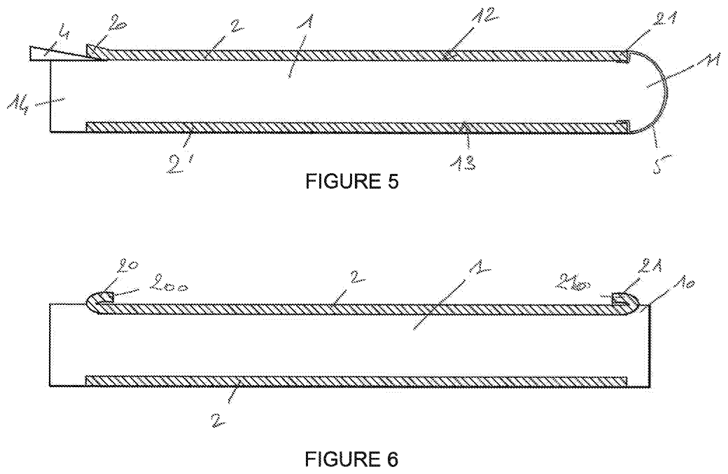

FIG. 5 shows a second variant, where a veil 5 has been disposed on the side 11 of the profiled member 1, in order to prevent embedding or covering of the peelply by carbon fibers and/or matrix. The edge 21 of the peelply 2 is independent from the profiled member, and can easily be seized. A veil 5 can be provided on both sides 11 and 14 of the profiled member 1. There is then no unsticking of the peelply 2.

FIG. 6 shows a third variant, where the peelply has been folded back at the ends 20 and 21, in order to make it possible for the rim 10 not to be able to come into contact with these ends 20 and 21 of the peelply. There is then no longer a risk of a residue of strip remaining after the peelply has been unstuck. There is then no unsticking of the peelply 2. The folded-back parts 202 and 210 can easily be detached by hand or with a blade.

### DETAILED DESCRIPTION OF AN EMBODIMENT

A description will now be provided of a preferred process for production of these profiled members.

The profiled member 1 is produced according to a process with a first standard molding or pultrusion part, with putting into place of at least one peelply 2, then the profiled member 1, still hot at the end of polymerization, passes in front of the blades (4, 40, 41) where at least one edge 20 of the peelply 2 is unstuck.

For the pultruded profiled members, there is impregnation of the fibers, drying, putting into place of the peelplies, then polymerization in the die, a start of unsticking of the peelply in the manufacturing line by the blades at the output from the die when the product is still at the appropriate temperature at the end of polymerization, traction of the pultruded profiled member, and winding along the flat parts with the peelplies started over all or part of the profiled member.

It can be envisaged to carry out the tearing away in cold conditions, although this is more complex to carry out since the adhesion and embedding of the strip on the die are greater, in particular for a PES strip on a profiled member made of carbon/epoxide.

It is also possible to carry out the tearing away in hot conditions outside the process of production of the profiled member. It is then necessary to carry out an additional step of heating of the profiled member at the moment of tearing away of the strip, either in line before the gluing of the profiled members to one another, or as reworking in the other cases.

1. A process for production of a profiled member, comprising a step of adhering a peelply, and a step of unsticking at least one edge of the peelply, in that the profiled member is pultruded, and in that the step of unsticking is carried out at the output from the die.

2. The process as claimed in claim 1, wherein the step of unsticking is carried out by a blade.

3. The process as claimed in claim 1, wherein the step of unsticking is carried out in hot conditions

4. The process as claimed in claim 1, wherein the step of unsticking is carried out during the polymerization.

5. The process as claimed in claim 2, wherein the blade has an inclination relative to the plane of the profiled member.

6. The process as claimed in claim 2, wherein the blade is aligned with the plane of the profiled member.

7. The process as claimed in claim 1, wherein the profiled member and the peelply are machined at the second edge of the peelply.

8. The process as claimed in claim 1, wherein a side of the profiled member is covered with a veil at the second edge of the peelply, and said veil is placed below the edge of said peelply.

9. The process as claimed in claim 1, wherein at least one edge of the peelply is folded back.

10. A profiled member with two faces having at least one peelply with two edges disposed and glued on a side of said profiled member, characterized in that it is produced by the process as claimed in claim 1.

11. An assembly comprising at least two profiled members as claimed in claim 1, wherein the two profiled members are glued to one another.
